(19) United States
(12) Patent Application Publication
(10) Pub. No.: US 2017/0037576 A1
(43) Pub. Date: Feb. 9, 2017

(54) 022913

(71) Applicant: MONDI AG, Wien (AT)

(72) Inventor: Walter Rüf, Wolfsberg (AT)

(73) Assignee: MONDI AG, Wien (AT)

(21) Appl. No.: 15/304,827

(22) PCT Filed: Apr. 22, 2015
(86) PCT No.: PCT/EP2015/058669

§ 371 Date: Oct. 17, 2016

(30) Foreign Application Priority Data
Apr. 28, 2014 (EP) 14166146.2

(51) Int. Cl. D21H 17/00; D21H 17/06; C08L 1/02; D21H 17/40; D21H 17/45; D21H 17/69; D21C 9/00; D21H 17/07

(52) U.S. Cl. CPC D21H 17/74; D21C 9/005; D21C 9/004; D21H 17/06; D21H 17/07; D21H 17/40; D21H 17/455; D21H 17/69; C08L 1/02; C08L 2207/04

(57) ABSTRACT

The present invention relates to a modified pulp. The modified pulp according to the invention contains
at least one substance a) selected from the group consisting of clays,
at least one substance b) selected from the group consisting of monomeric, oligomeric or polymeric quaternary ammonium compounds and
at least one substance c) selected from the group consisting of alkoxylated fatty alcohols.

The invention also relates to the use of the pulp according to the invention for the production of pulp/plastic composite materials.

U.S. Pat. No. 4,432,833; U.S. Pat. No. 6,296,737; EP 2 464 681 A1; U.S. Pat. No. 5,068,009; U.S. Pat. No. 5,776,308; WO 2012/012633; EP 0 458 657 A; EP 0 132 128 A1; U.S. Pat. No. 7,186,316; U.S. Pat. No. 3,556,931; U.S. Pat. No. 6,748,671; WO 2006/048332; US 2006/091578; WO 2006/049972; US 2006/084729; DE 10 2004 034039; US 2005/225009; U.S. Pat. No. 6,942,829; U.S. Pat. No. 6,743,507; EP 1 567 586 A; WO 2000/063486; EP 0 116 512 A; DE 3 119 907 A; U.S. Pat. No. 3,755,220; WO 2007/056839; U.S. Pat. No. 6,632,863; EP 0 747 419; EP 0 633 963 A; WO 2011/018383, EP 1 013 825 A1, WO 2011/120875, WO 00/62730.

The present invention relates to a modified pulp, a method for its preparation as well as to its use.

In particular, the present invention relates to a modified pulp which, together with plastics, can be compounded into a composite material.

The production of composite materials from cellulosic materials such as, e.g., pulp and one or several plastics is known.

It is likewise known to chemically modify pulp in order to reduce the fibre-fibre bond of the pulp. This influence is also referred to as “debonding”. In this way, the connectability of the pulp to further components, in particular plastics for the production of a composite material, is improved.

The literature contains numerous recommendations regarding substances and compounds suitable for such a modification. By way of example, the following publications are to be mentioned:

In many of those documents (such as, e.g., in EP 1 013 825 A1), the modification of the pulp is performed with the production of paper in mind. In contrast, the present invention deals with the modification of pulp for compounding with a plastic. The pulp as the starting product for said compounding is usually provided in loose form, i.e., in the form of a loose arrangement of cellulose fibres, in contrast to paper.

As possible debonders, many different groups of substances and compounds are recommended in the literature. Quaternary ammonium compounds are mentioned frequently.

In the above-mentioned recommendations, substances modifying the pulp are, in part, added only when the mixing with a plastic for the production of a composite material occurs.

In contrast, the present invention relates to a modification of the pulp for the preparation of a pre-product, which can then be compounded with one or several plastics to form a composite material.

Despite the numerous recommendations found in literature, there is still a need for suitable modified pulps which are well suited for further processing for the production of composite materials.

In the following, the suitability for further processing is defined on the basis of the characteristic number of the “tensile strength index” (ZFI). The tensile strength index ZFI indicates the breaking resistance of a pulp with regard to width and length in the unit Nm/g. The lower the tensile strength index of a modified pulp, the more weakened are the fibre-fibre bonds within the pulp and the better suited is the modified pulp for further processing into a composite material.

The object of the present invention is achieved by a modified pulp containing

at least one substance a) selected from the group consisting of clays,

at least one substance b) selected from the group consisting of monomeric, oligomeric or polymeric quaternary ammonium compounds and

at least one substance c) selected from the group consisting of alkoxylated fatty alcohols.

It has become apparent that a pulp modified with a combination of the substances a), b) and c) exhibits a low tensile strength index and is excellently suitable for further processing into composite materials.

In this context, it has surprisingly been shown that substances of group a), which, on their own, have no or only a minor impact on the tensile strength index, apparently increase the effect of a combination of substances of groups b) and c) in a synergistic manner

The substance a) is selected from the group of clays. Preferably, the substance a) is a bentonite.

The clay may optionally be provided in modified form. The use of clays modified with quaternary ammonium compounds is possible as well. Nevertheless, in such a case, the separate use of a substance of group b) is still required.

The substance b) is selected from the group consisting of monomeric, oligomeric or polymeric quaternary ammonium compounds.

In a preferred embodiment of the present invention, the substance b) is selected from the group consisting of di-fatty acid residue dimethyl ammonium compounds, fatty acid residue trimethyl ammonium compounds, esterquats substituted with one or several fatty acid residues and imidazolium compounds, and mixtures thereof.

The length of the fatty acid residue(s) in the di-fatty acid residue dimethyl ammonium compounds, fatty acid residue trimethyl ammonium compounds, esterquats and imidazolium compounds of substance b) may range from 8 to 20 carbon atoms, preferably from 12 to 18 carbon atoms, particularly preferably from 16 to 18 carbon atoms.

Particularly preferably, the fatty acid residue(s) is/are selected from the group consisting of stearic acid, coconut fatty acids, tallow fatty acids and mixtures thereof.

In a particularly preferred embodiment of the present invention, the substance b) is di-tallow dimethyl ammonium chloride. Di-tallow dimethyl ammonium chloride is, for example, a component of the commercially available products Arquad® 2T-70 (manufacturer: Akzo Nobel) or Praepagen 3445 (manufacturer: Clariant).

Imidazolium compounds and imidazolium derivatives, respectively, substituted with one or several fatty acid residues come into consideration as imidazolium compounds. The heterocycle may be provided in a completely unsaturated or in a partially saturated state. Preferably, substances of the structural formula (I)

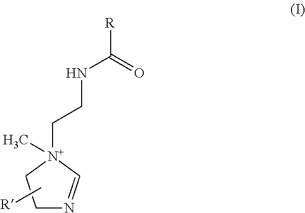

are used, wherein R′ represents one or several substituents on the imidazol ring and the residues R and R′ are, equally or differently from each other, saturated or unsaturated fatty acid residues comprising 16 to 18 carbon atoms. Preferably, R′ is a substituent at the 2-position of the imidazol ring. A commercially available product is, for example, Arosurf PA844 (manufacturer: Evonik).

In a further preferred embodiment of the present invention, the substance b) is selected from the group consisting of polymers or copolymers from N,N-dialkyl aminoalkyl acrylate monomers.

In said embodiment of the present invention, a polymeric compound with quaternary ammonium groups is formed via the polymerization of the N,N-dialkyl aminoalkyl acrylate with itself or, respectively, by copolymerization with a suitable comonomer a person skilled in the art is familiar with.

Ethylene copolymers which are obtained by copolymerization with N,N-dialkyl aminoalkyl acrylates (amongst others, if applicable) are described in WO 2011/018383 A1.

Preferably, the two N,N-alkyl radicals of the N,N-dialkyl aminoalkyl acrylate are, equally or differently from each other, methyl and ethyl.

A particularly preferred monomer is N,N-dimethyl aminoalkyl acrylate (DMAEA).

For all quaternary ammonium compounds of the group of substances b), the counterion is preferably selected from the group consisting of halogens, in particular chloride, CH₃SO₄⁻, SO₄²⁻, CH₃COO⁻ as well as mixtures thereof.

Substances selected from the group consisting of alkoxylated fatty alcohols are used according to the invention as substance c).

In substance c), the length of the fatty acid residue may range from 8 to 20 carbon atoms, preferably from 10 to 18 carbon atoms, particularly preferably from 12 to 16 carbon atoms.

The alkoxy group in substance c) is preferably selected from the group consisting of ethoxy and/or propoxy. Preferably, the alkoxy group is provided in an oligomeric form comprising 2 to 60 alkoxy moieties, particularly preferably 5 to 10 alkoxy moieties.

Suitable products of the group of substances c) are, for example, the commercially available products Plurafac® LF403 (manufacturer: BASF) and Sursol VL (manufacturer: BASF).

The modified pulp according to the invention is preferably characterized by the following proportions of the substances a), b) and c):

substance a): <10% by weight, preferably<5% by weight, particularly preferably 3% by weight or less, especially preferably at least 0.3% by weight,

substance b): <10% by weight, preferably<5% by weight, particularly preferably 3% by weight or less, especially preferably at least 0.5% by weight,

substance c): <10% by weight, preferably<5% by weight, particularly preferably 3% by weight or less, especially preferably at least 0.5% by weight.

In a particularly preferred embodiment, all three substances a) to c) are each provided at a proportion of 3% by weight or less.

It has been shown that, via the modification according to the invention with the combination of the substances a), b) and c), a modified pulp can be obtained which is characterized by a tensile strength index (ZFI) of 8 Nm/g or less. The method of determining the tensile strength index is illustrated below in the example section.

The pulp according to the invention is preferably provided in loose form, i.e., in the form of a loose arrangement of cellulose fibres. The bulk density of the pulp according to the invention may typically range from 110 to 140 kg/m³, with the humidity of the pulp amounting to 5 to 8% by weight, based on the weight of the pulp (including humidity).

The bulk density can be measured according to DIN 53468/ISO 697, but with the collecting vessel having larger dimensions in contrast to said standard. In concrete terms, a dry and clean 10 L bucket is placed on a balance and tared. The loose pulp is filled into the bucket using a shovel. Compaction is effected only as a result of gravity, pressing does not occur. The excess is removed by means of a metal ruler, and the mass of the pulp is determined.

The pulp according to the invention may also be provided in a pressed form such as, e.g., in the form of pulp bales or in the form of pulp sheets. In such a case, the pressed pulp is separated back into a loose form, for example, mechanically, before compounding with a plastic takes place.

In any case, however, the pulp according to the invention does not exhibit the distinct bonds between the individual cellulose fibres, which are characteristic of paper.

The method for the production of the modified pulp according to the invention is characterized by the homogeneous mixing of a pulp with the substances a), b) and c) in an aqueous suspension.

Preferably, mixing takes place in a pulper.

Therefore, the pulp according to the invention is preferably characterized in that it is obtainable by mixing the pulp with the substances a), b) and c) in an aqueous suspension in a pulper. The product which is obtained thereby, if applicable, after drying, is a loose pulp which, in this form, can be compounded with a plastic.

The duration of mixing the pulp with the substances a), b) and c) may be 30 minutes or less, preferably 20 minutes or less, particularly preferably 10 minutes or less.

The temperature during the process may be 10° C.-90° C., preferably 20° C.-70° C., particularly preferably 50° C. to 60° C.

Basically all well-established pulp types are suitable for the production of the pulp according to the invention.

In particular, both long-fibre and short-fibre pulps (i.e., softwood or hardwood pulps) may be used.

As the underlying type of wood, particularly pine, spruce, birch and eucalyptus are suitable.

The pulp may be used both in the form of a bale and as a sheet pulp.

The present invention also relates to the use of the pulp according to the invention for compounding with a plastic, in particular for the production of a composite material.

The plastic to be used for compounding is preferably selected from the group of thermoplastic polymers, in particular polyethylene, polyproplyene, copolymers and mixtures thereof.

Copolymers can be composed in particular from polyethylene and polypropylene. Polyvinyl chloride, polylactic acid, acrylonitrile-butadiene-styrene polymers, polyoxymethylene, polyamides, polybutylene terephthalate, polycarbonates, polymethyl methacrylates and polyethylene terephthalate are to be mentioned as further suitable plastics.

In further consequence, the present invention relates to a pulp/plastic composite material which is obtainable by compounding the modified pulp according to the invention with a plastic.

A person skilled in the art is per se familiar with the production of pulp/plastic composite materials, for which reason a more detailed description of possible process techniques for that purpose may be omitted herein.

In the following, the present invention is illustrated in further detail on the basis of examples of preferred embodiments.

### EXAMPLES

### Determination of the Tensile Strength Index (ZFI)

The ZFI of the modified and unmodified pulps as described below was determined according to ISO 1924/3. The pulp sheets required for the determination were produced in accordance with ISO 5264-2 and ISO 5269-2, wherein the breaking-down period, in devation from the standard, was chosen to be 3,000 revolutions instead of 30,000 revolutions (which corresponds to 1 minute instead of 10 minutes).

### Example Group 1

### Starting Pulp

### Comparative Example

A commercially available pulp of the type Södra Green Z85 (a sulphate pulp based on softwood) was used as the starting pulp. The ZFI measured for this pulp amounted to 25.3 Nm/g. In the technical data sheet, the ZFI is indicated to be 26.

### Pulp Modification

Unless indicated otherwise, in the examples indicated below, the pulp was, in each case, treated with the respective modifying substances as follows:

66 g pulp is left to swell in 2 litres of water at room temperature and subsequently is broken down with 30000 revolutions (10 min) together with the additive chemicals.

The standard sheets were produced directly from the wet pulp as described above.

In the following tables, the percentage degree of debonding, based on the ZFI of the untreated starting pulp (25.3 Nm/g), is indicated in addition to the tensile strength index (ZFI) measured for each modified pulp.

### Pulps Modified Not According to the Invention

### Comparative Examples

TABLE 1

| Ex. | | | | | | | | % de- |
|---|---|---|---|---|---|---|---|---|
| No. | % | substance a | % | substance b | % | substance c | ZFI | bonding |
| C1 | 3 | Opazil AOG | | | | | 24.5 | 3.20 |
| C2 | 1 | Pitchbent K | | | | | 23.8 | 5.93 |
| C3 | 2 | Pitchbent K | | | | | 23.6 | 6.72 |
| C4 | 3 | Pitchbent K | | | | | 23.2 | 8.30 |
| C5 | | | 1.2 | Arquad T 50 | | | 14.2 | 43.87 |
| C6 | | | 0.5 | Arquad 2T-70 | | | 11.4 | 54.94 |
| C7 | | | 1 | Arquad 2T-70 | | | 10.6 | 58.10 |
| C8 | | | 0.5 | Arquad 2C-75 | | | 12.5 | 50 |
| C9 | | | | | 2 | Plurafac LF403 | 17.5 | 30.83 |
| C10 | | | | | 2 | Sursol VL | 18.2 | 28.06 |
| C11 | | | 1 | Arquad 2T-70 | 1 | Sursol VL | 9.1 | 64.03 |
| C12 | | | 0.5 | Arquad T 50 | 1 | Sursol VL | 9.03 | 64.31 |
| C13 | | | 0.5 | Arquad 2T-70 | 1 | Plurafac LF 403 | 9.4 | 62.80 |
| C14 | | | 0.5 | Arquad 2T-70 | 1 | Sursol VL | 9 | 64 |

The products Opazil AOG and Pitchbent K are each based on bentonite.

Arquad T 50 is based on tallow trimethyl ammonium chloride.

Arquad 2T-70 is based on di-tallow dimethyl ammonium chloride.

Arquad 2C-75 is based on dicoco dimethyl ammonium chloride.

From Table 1, it is evident that the modification of the starting pulp only with substances of group a) (clays) has only a very small impact on the ZFI.

The modification with substances of group b) and group c) as well as of combinations of substances of group b) and group c) cause a stronger reduction in the ZFI, which, however, would still be too high for most applications, in particular for the further processing into pulp/plastic composite materials.

### Pulps Modified According to the Invention

TABLE 2

| Ex. | | | | | | | | % de- |
|---|---|---|---|---|---|---|---|---|
| No. | % | substance a | % | substance b | % | substance c | ZFI | bonding |
| 1.1 | 1 | Opazil AOG | 1 | Arquad 2T-70 | 1 | Plurafac | 5.7 | 77.20 |
| | | | | | | LF403 | | |
| 1.2 | 1 | Pitchbent K | 1 | Arquad 2T-70 | 1 | Plurafac | 6.15 | 75.69 |
| | | | | | | LF403 | | |
| 1.3 | 2 | Pitchbent K | 1.5 | Arquad 2T-70 | 1.5 | Plurafac | 4.7 | 81.20 |
| | | | | | | LF403 | | |
| 1.4 | 2 | Pitchbent K | 1.5 | Arquad 2T-70 | 1.5 | Sursol VL | 5.2 | 79.20 |
| 1.5 | 2 | Pitchbent K | 2 | Arquad 2T-70 | 2 | Plurafac | 4.4 | 82.40 |
| | | | | | | LF403 | | |
| 1.6 | 2 | Pitchbent K | 2 | Arquad 2T-70 | 2 | Sursol VL | 4.6 | 81.60 |
| 1.7 | 1 | Pitchbent K | 1 | Tuxol Q AHC | 1 | Sursol VL | 6.4 | 74.40 |
| 1.8 | 2 | Pitchbent K | 0.5 | Arquad 2C-75 | 3 | Sursol VL | 10.7 | 57.20 |
| 1.9 | 2 | Pitchbent K | 1.5 | Varisoft TA | 1.5 | Sursol VL | 5.8 | 76.80 |
| | | | | 100 | | | | |
| 1.10 | 1 | Garamite | 1 | Arquad 2T-70 | 1 | Plurafac | 7.5 | 72.22 |
| | | 1958 | | | | LF403 | | |
| 1.11 | 2 | Nanofil 116 | 2 | Arquad 2T-70 | 2 | Plurafac | 6.6 | 75.56 |
| | | | | | | LF403 | | |
| 1.12 | 2 | Garamite | 2 | Arquad 2T-70 | 2 | Plurafac | 6.96 | 74.22 |
| | | 1958 | | | | LF403 | | |

The product “Garamite 1958” is a clay modified with quaternary alkyl ammonium.

The product “Nanofil 116” is based on bentonite.

Tuxol Q AHC is based on di-tallow dimethyl ammonium chloride.

Varisoft TA 100 is based on distearyl dimethyl ammonium chloride.

From Table 2, it is evident that, with a combination of the substances of groups a), b) and c), significantly lower tensile stregths and thus a much higher degree of debonding can be achieved than with the substances alone or only in a combination of two of the substances. Particularly the use of clays of group a), which, intrinsically, produce hardly any effect on their own, seems to significantly improve the effect of a combination of substances of the groups b) and c).

As is likewise evident from Table 2, with the combination according to the invention of substances a), b) and c), tensile strength indices of 8 Nm/g or less can be achieved, which renders the pulps modified according to the invention excellently suitable for further processing into pulp/plastic composite materials.

### Example Group 2

### Starting Pulp

A commercially available pulp of the type Suzano (a sulphate pulp based on eucalyptus, bleached) was used as the starting pulp. The ZFI measured for this pulp amounted to 22.4 Nm/g.

In each case, the pulp modification occurred as described for example group 1.

The results are summarized in the following Table 3:

| Ex. | | | | | | | | % de- |
|---|---|---|---|---|---|---|---|---|
| No. | % | substance a | % | substance b | % | substance c | ZFI | bonding |
| 2.1 | 2 | Papercol PF | 1.5 | Arquad 2T-70 | 2 | Plurafac | 7.53 | 66.41 |
| | | | | | | LF403 | | |
| 2.2 | 2 | Pitchbent K | 1.5 | Arquad 2T-70 | 2 | Sursol VL | 5.06 | 77.43 |
| 2.3 | 2 | Pitchbent K | 1.5 | Arquad 2T-70 | 2 | Marlosol | 5.34 | 76.18 |
| | | | | | | TA3030 | | |
| 2.4 | 2 | Pitchbent K | 1.5 | Arquad 2T-70 | 2 | Marlowet | 5.24 | 76.63 |
| | | | | | | 4702 | | |
| 2.5 | 2 | Pitchbent K | 1.5 | Arquad 2T-70 | 2 | Emulan P | 6.46 | 71.19 |
| 2.6 | 2 | Pitchbent K | 1.5 | Arquad 2T-70 | 2 | Hoesch SH | 6.47 | 71.14 |
| | | | | | | 55/95 PF | | |
| 2.7 | 2 | Pitchbent K | 1.5 | Arquad 2T-70 | 2 | Plurafac | 5.50 | 75.47 |
| | | | | | | LF403 | | |
| 2.8 | 2 | Pitchbent K | 1.5 | Varisoft TA | 2 | Plurafac | 6.57 | 70.70 |
| | | | | 9100 | | LF403 | | |
| 2.9 | 2 | Pitchbent K | 1.5 | Arosurf PA842 V | 2 | Plurafac | 5.10 | 77.25 |
| | | | | | | LF403 | | |
| 2.10 | 2 | Pitchbent K | 1.5 | Praepagen TQ | 2 | Plurafac | 5.87 | 73.82 |
| | | | | | | LF403 | | |
| 2.11 | 2 | Pitchbent K | 2 | Praepagen TQ | 2 | Plurafac | 5.83 | 74.00 |
| | | | | | | LF403 | | |
| 2.12 | 2 | Pitchbent K | 1.5 | Arquad HTB-75 | 2 | Plurafac | 6.64 | 70.38 |
| | | | | | | LF403 | | |
| 2.13 | 2 | Pitchbent K | 1.5 | Armeen HAT | 2 | Plurafac | 7.53 | 66.41 |
| | | | | | | LF403 | | |
| 2.14 | 2 | Pitchbent K | 1.5 | Armeen T | 2 | Plurafac | 5.46 | 75.65 |
| | | | | | | LF403 | | |
| 2.15 | 2 | Pitchbent K | 1.5 | Varisoft TA | 2 | Sursol VL | 5.48 | 75.56 |
| | | | | 100 | | | | |
| 2.16 | 2 | Pitchbent K | 2 | Arosurf PA842 V | 2 | Marlosol | 5.55 | 75.25 |
| | | | | | | TA3030 | | |
| 2.17 | 2 | Pitchbent K | 3 | Praepagen TQ | 2 | Emulan P | 5.95 | 73.46 |
| 2.18 | 2 | Pitchbent K | 3 | Praepagen TQ | 2 | Marlosol | 5.24 | 76.63 |
| | | | | | | TA3030 | | |
| 2.19 | 2 | Pitchbent K | 0.75 | Arquad 2T-70 | 2 | Plurafac | 9.02 | 59.77 |
| | | | | | | LF403 | | |
| 2.20 | 2 | Pitchbent K | 1 | Arquad 2T-70 | 2 | Plurafac | 8.76 | 60.93 |
| | | | | | | LF403 | | |
| 2.21 | 2 | Pitchbent K | 1.5 | Arquad 2T-70 | 1 | Plurafac | 12.93 | 42.33 |
| | | | | | | LF403 | | |
| 2.22 | 2 | Pitchbent K | 1.5 | Arquad 2T-70 | 1.5 | Plurafac | 9.08 | 59.50 |
| | | | | | | LF403 | | |
| 2.23 | 0.75 | Pitchbent K | 1.5 | Arquad 2T-70 | 2 | Plurafac | 5.57 | 75.16 |
| | | | | | | LF403 | | |
| 2.24 | 0.5 | Pitchbent K | 1.5 | Arquad 2T-70 | 2 | Plurafac | 5.82 | 74.04 |
| | | | | | | LF403 | | |
| 2.25 | 0.4 | Pitchbent K | 1.5 | Arquad 2T-70 | 2 | Plurafac | 5.73 | 74.44 |
| | | | | | | LF403 | | |
| 2.26 | 0.3 | Pitchbent K | 1.5 | Arquad 2T-70 | 2 | Plurafac | 5.54 | 75.29 |
| | | | | | | LF403 | | |
| 2.27 | 2 | Opazil | 1.5 | Arquad 2T-70 | 2 | Plurafac | 5.80 | 74.13 |
| | | | | | | LF403 | | |
| 2.28 | 2 | Papercol PF | 1.5 | Arquad 2T-70 | 2 | Plurafac | 7.53 | 66.41 |
| | | | | | | LF403 | | |
| 2.29 | 2 | Laviofloc | 1.5 | Arquad 2T-70 | 2 | Plurafac | 5.31 | 76.32 |
| | | P2G | | | | LF403 | | |

Marlosol TA3030 is based on ethoxylated isotridecanol.
Marlowet 4702 is based on an oleic acid polyethylene glycol diester.
Emulan P is based on ethoxylated C12-C14 alcohols.
Hoesch SH 55/95 is based on an oleylcetyl-5,5-polyglycol ether.
Arosurf PA 842 V is based on a 2-C17-unsaturated alkyl-1-(2-C18-unsaturated amidoethyl)-4,5-dihydro-N-methyl imidazolium salt.
Praepagen TQ is based on a triethanolamine di-esterquat methosulphate comprising essentially C16/C18 saturated and unsaturated fatty acids.
Arquad HTB-75 is based on C16-18-alkyl dimethyl ammonium chlorides.
Armeen HAT and Armeen T are each based on tallow amines.
Papercol PF and Laviofloc P2G are each based on bentonite.

1. A modified pulp comprising:
at least one substance a) selected from the group consisting of clays,
at least one substance b) selected from the group consisting of monomeric, oligomeric or polymeric quaternary ammonium compounds and
at least one substance c) selected from the group consisting of alkoxylated fatty alcohols.

2. A modified pulp according to claim 1, wherein the substance a) is a bentonite.

3. A modified pulp according to claim 1, wherein the substance b) is selected from the group consisting of di-fatty acid residue dimethyl ammonium compounds, fatty acid residue trimethyl ammonium compounds, esterquats substituted with one or several fatty acid residues and imidazolium compounds, and mixtures thereof.

4. A modified pulp according to claim 3, wherein the length of the fatty acid residue(s) in the di-fatty acid residue dimethyl ammonium compounds, fatty acid residue trimethyl ammonium compounds, esterquats substituted with one or several fatty acid residues and imidazolium compounds of substance b) ranges from 8 to 20 carbon atoms.

5. A modified pulp according to claim 3, wherein the fatty acid residue(s) is/are selected from the group consisting of stearic acid, coconut fatty acids, tallow fatty acids and mixtures thereof.

6. A modified pulp according to claim 5, wherein the substance b) is di-tallow dimethyl ammonium chloride.

7. A modified pulp according to claim 1, wherein the substance b) is selected from the group consisting of polymers or copolymers from N,N-dialkyl aminoalkyl acrylate monomers.

8. A modified pulp according to claim 3, wherein the counterion of the quaternary ammonium compound is selected from the group consisting of halogens, chloride, CH₃SO₄⁻, SO₄²⁻, CH₃COO⁻ and mixtures thereof.

9. A modified pulp according to claim 1, wherein the length of the fatty acid residue in substance c) ranges from 8 to 20 carbon atoms.

10. A modified pulp according to claim 1, wherein the alkoxy group in substance c) is selected from the group consisting of ethoxy and/or propoxy.

11. A modified pulp according to claim 1, characterized by the following proportions of the substances a), b) and c):
substance a): <10% by weight,
substance b): <10% by weight,
substance c): <10% by weight.

12. A modified pulp according to claim 1, characterized by a tensile strength index (ZFI) of 8 Nm/g or less.

13. A modified pulp according to claim 1, wherein the pulp is provided in loose form or in a pressed form.

14. A modified pulp according to claim 1, wherein it is obtainable by mixing a pulp with the substances a), b) and c) in an aqueous suspension in a pulper.

15. (canceled)

16. (canceled)

17. A pulp/plastic composite material, obtainable by compounding a modified pulp according to claim 1 with a plastic.

18. A pulp/plastic composite material according to claim 17, wherein the plastic is selected from the group of consisting of thermoplastic polymers, polyethylene, polyproplyene, copolymers, and mixtures thereof.

19. A modified pulp according to claim 3, wherein the length of the fatty acid residue(s) in the di-fatty acid residue dimethyl ammonium compounds, fatty acid residue trimethyl ammonium compounds, esterquats substituted with one or several fatty acid residues and imidazolium compounds of substance b) ranges from 12 to 18 carbon atoms.

20. A modified pulp according to claim 1, wherein the length of the fatty acid residue in substance c) ranges from 10 to 18 carbon atoms.

21. A modified pulp according to claim 13, wherein the pulp provided in loose form or in a pressed form is in the form of pulp bales or pulp sheets.

22. A modified pulp according to claim 11, characterized by the following proportions of the substances a), b) and c):
substance a): at least 0.3% by weight and less than 5% by weight,
substance b): at least 0.5% by weight and less than 5% by weight,
substance c): at least 0.5% by weight and less than 5% by weight.
